(19) United States
(12) Patent Application Publication
(10) Pub. No.: US 2024/0278149 A1
(43) Pub. Date: Aug. 22, 2024

(54) APPARATUS AND ELECTRONIC DEVICE FOR REDUCING BUBBLES IN LIQUID

(71) Applicant: Lenovo (Beijing) Limited, Beijing (CN)

(72) Inventors: Na YIN, Beijing (CN); Yiming JIA, Beijing (CN)

(21) Appl. No.: 18/583,076

(22) Filed: Feb. 21, 2024

(30) Foreign Application Priority Data
Feb. 21, 2023 (CN) 202310144099.1

(51) Int. Cl. B01D 19/00

(52) U.S. Cl. CPC B01D 19/0094; B01D 19/0068

(57) ABSTRACT

An apparatus for reducing bubbles in liquid includes: a bubble elimination structure including a plurality of bubble breaking elements being used to reduce the bubbles in the liquid, an axial direction of each bubble breaking element being consistent with a liquid flow direction; and a spiral structure configured to generate a spiral movement of the liquid around the liquid flow direction to concentrate the bubbles in the liquid in the center of the liquid. The liquid flows through the spiral structure before flowing through the bubble elimination structure.

### CROSS-REFERENCE TO RELATED APPLICATION

This application claims priority to Chinese Patent Application No. 202310144099.1, filed on Feb. 21, 2023, and the entire content of which is incorporated herein by reference.

### TECHNICAL FIELD

The present disclosure relates to the technical field of reducing bubbles in liquid, and more particularly, to an apparatus and an electronic device for reducing bubbles in liquid.

### BACKGROUND

With the development of computer technology, the central processing unit, graphics card and motherboard in a computer generate more and more heat during operation. In order to keep the computer running efficiently, it is necessary to dissipate heat from these heat generating components in the computer.

In the related art, water cooling is used to dissipate heat and cool down components in computers that generate substantial amounts of heat. During an initial operation of a water-cooling system, a water pump needs to be used to gradually fill an entire pipeline of the water-cooling system with a cooling liquid. However, during the process of injecting the cooling liquid into the pipeline of the water-cooling system, the air in the pipeline may not be completely discharged. Some bubbles may exist in the pipeline. When discharging the air, the cooling liquid needs to be circulated for a period of time to allow the remaining bubbles in the pipeline to escape. Because the pipelines of most water-cooling systems are relatively complex, the process of discharging bubbles by circulating the cooling liquid in the pipelines will take a long time. As such, on the one hand, it will consume a lot of time. On the other hand, during the operation of the water-cooling system, as a temperature of the cooling liquid in the water-cooling system increases, more bubbles may appear and bubbles grow larger. The bubbles remaining in gaps between cold plate fins will form a large thermal resistance, which will weaken the heat exchange effect with devices that generate large amounts of heat. Further, too many bubbles will cause cavitation of a circulation pump in the water-cooling system, thereby shortening the service life of the circulation pump.

Currently, the way to discharge water-cooling systems primarily relies on automatic discharge valves. The automatic discharge valves may often only be installed at the top of the pipeline of the water-cooling system, and various valves and the pipeline in the water-cooling system are prone to bubbles. The automatic discharge valves may not effectively and timely reduce the bubbles. The sticky bubbles are dispersed into the cooling liquid in the pipeline, which will weaken the heat dissipation capacity of the water-cooling system.

### SUMMARY

One aspect of the present disclosure provides an apparatus for reducing bubbles in liquid. The apparatus includes: a bubble elimination structure including a plurality of bubble breaking elements being used to reduce the bubbles in the liquid, an axial direction of each bubble breaking element being consistent with a liquid flow direction; and a spiral structure configured to generate a spiral movement of the liquid around the liquid flow direction to concentrate the bubbles in the liquid in the center of the liquid. The liquid flows through the spiral structure before flowing through the bubble elimination structure.

Another aspect of the present disclosure provides an electronic device. The electronic device includes: a heating element generates a large amount of heat during operation; and a liquid cooling system configured to cool down the heating element and including a liquid delivery pipeline connected to the heating element and an apparatus for reducing bubbles in liquid arranged in the liquid delivery pipeline and configured to reduce bubbles in the liquid circulated in the liquid delivery pipeline. The apparatus for reducing bubbles in liquid includes: a bubble elimination structure including a plurality of bubble breaking elements being used to reduce the bubbles in the liquid, an axial direction of each bubble breaking element being consistent with a liquid flow direction; and a spiral structure configured to generate a spiral movement of the liquid around the liquid flow direction to concentrate the bubbles in the liquid in the center of the liquid. The liquid flows through the spiral structure before flowing through the bubble elimination structure.

### BRIEF DESCRIPTION OF THE DRAWINGS

FIG. 1 is a schematic diagram of an exemplary liquid cooling system in an electronic device according to some embodiments of the present disclosure;

FIG. 2 is a schematic diagram of operation principle of an exemplary apparatus for reducing bubbles in liquid according to some embodiments of the present disclosure;

FIG. 3 is a schematic diagram of operation principle of another exemplary apparatus for reducing bubbles in liquid according to some embodiments of the present disclosure;

FIG. 4 is a schematic structural diagram of an exemplary apparatus for reducing bubbles in liquid according to some embodiments of the present disclosure;

FIG. 5 is a schematic structural diagram of another exemplary apparatus for reducing bubbles in liquid according to some embodiments of the present disclosure;

FIG. 6 is a cross-sectional view of an exemplary apparatus for reducing bubbles in liquid according to some embodiments of the present disclosure;

FIG. 7 is a cross-sectional view of another exemplary apparatus for reducing bubbles in liquid according to some embodiments of the present disclosure;

FIG. 8 is a cross-sectional view of another exemplary apparatus for reducing bubbles in liquid according to some embodiments of the present disclosure; and

FIG. 9 is a cross-sectional view of another exemplary apparatus for reducing bubbles in liquid according to some embodiments of the present disclosure.

Brief description of reference numerals in the drawings: 1 liquid delivery pipeline; 2 apparatus for reducing bubbles in liquid; 21 bubble elimination structure; 211 bubble breaking element; 212 through-hole; 213 circulation channel; 22 spiral structure; 221 wedge; 2211 first curved surface; 2212 second curved surface; 222 spiral channel; 223 stopper; 2231 liquid flow channel; 224 spiral flow guide; 23 flow guide housing; 24 flow guide structure; 241 flow guiding element; 242 flow draining element; 2421 flow drainer hole; 2422 connection arm; A liquid flow direction; B rotation direction; C direction of spiral channel.

### DETAILED DESCRIPTION OF THE EMBODIMENTS

The technical solutions of the present disclosure will be further described in detail below with reference to the accompanying drawings and various embodiments of the description.

In the embodiments of the present disclosure, it should be noted that, unless otherwise clearly stated and limited, the term “connection” should be understood in a broad sense. For example, “connection” may be a fixed connection, a detachable connection, or an integrated connection. It may be directly connected or indirectly connected through an intermediary.

It should be noted that the terms “first\second\third” involved in the embodiments of the present disclosure are merely used to distinguish similar objects and do not represent a specific ordering of objects. It should be understood that the specific order or sequence described by “first\second\third” may be interchanged where permitted. It should be understood that the “first\second\third” distinction may be interchanged under appropriate circumstances such that the embodiments of the present disclosure described herein may be practiced in sequences other than those illustrated or described herein.

FIG. 1 is a schematic diagram of an exemplary liquid cooling system in an electronic device according to some embodiments of the present disclosure. The electronic device provided by the embodiments of the present disclosure may be any electronic device including a liquid cooling system. As long as the electronic device is cooled by the liquid cooling system, it can be included in the scope of the embodiments of the present disclosure. For example, the electronic device may be a desktop computer, a server, an all-in-one computer, a projector, etc. For ease of description, the following uses a computer and a water-cooling system as examples to describe the electronic device provided by the embodiments of the present disclosure, but this is not intended to limit the electronic device provided by the embodiments of the present disclosure.

As shown in FIG. 1, the electronic device provided by the embodiments of the present disclosure includes: a heating element and a liquid cooling system. The heating element generates a large amount of heat during operation. The liquid cooling system includes a liquid delivery pipeline 1 and an apparatus 2 for reducing bubbles in liquid. The liquid delivery pipeline 1 is connected to the heating element. The heating element may be cooled down through the liquid cooling system to keep a temperature of the heating element stable. The apparatus 2 for reducing bubbles in liquid is arranged in the liquid delivery pipeline 1. The device 2 for reducing bubbles in the liquid can reduce the bubbles in the liquid flowing in the liquid delivery pipeline 1, such that the bubbles in the liquid delivery pipeline 1 have minimal effect on the heat exchange efficiency, and cause little cavitation damage to parts in the liquid cooling system. Thus, the operation efficiency of the liquid cooling system is improved and the service life of the liquid cooling system is extended.

For example, a water-cooling system is configured in a computer, and the liquid delivery pipeline 1 of the water-cooling system is connected to a central processing unit (CPU) of the computer. Cooling water is circulated in the liquid delivery pipeline 1 through a water pump to absorb the heat generated by the CPU such that the CPU can be kept at a constant temperature without overheating. At the same time, an apparatus 2 for reducing bubbles in liquid is provided in the liquid delivery pipeline 1 to reduce bubbles in the cooling water.

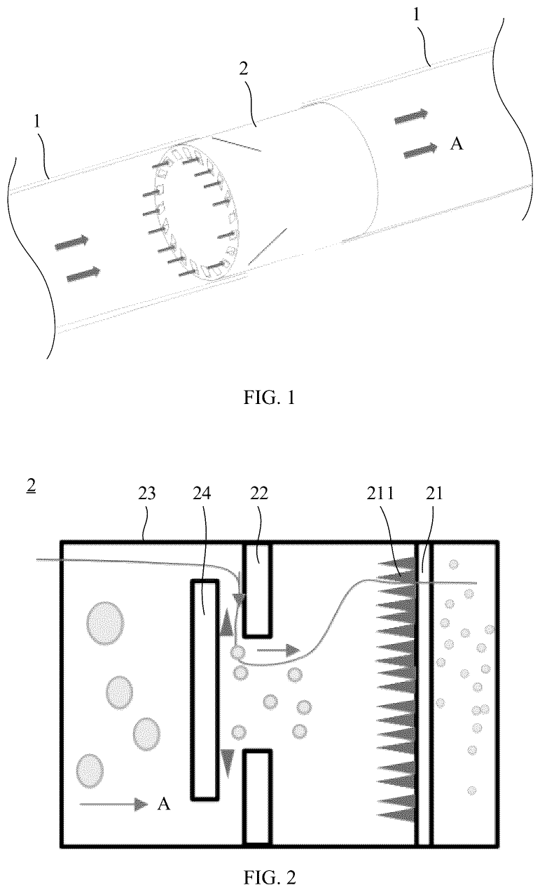

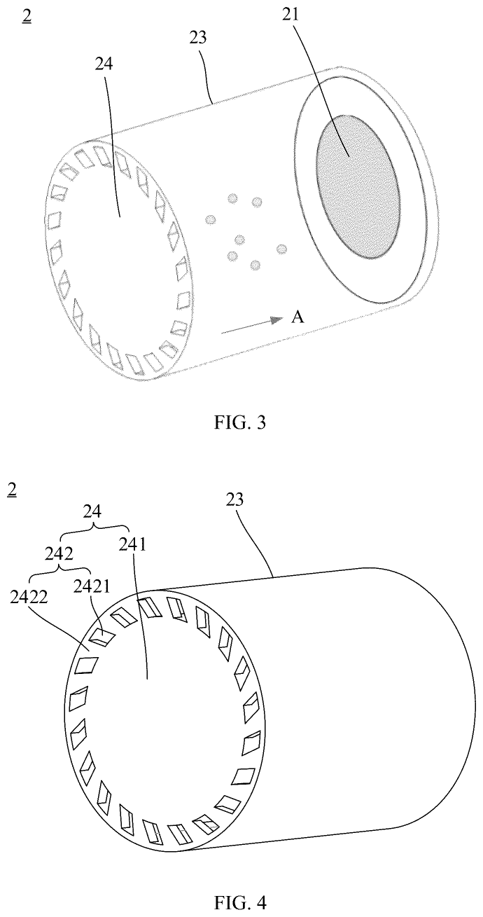

At the same time, the present disclosure also provides an apparatus for reducing bubbles in liquid. FIG. 2 is a schematic diagram of operation principle of an exemplary apparatus for reducing bubbles in liquid according to some embodiments of the present disclosure. FIG. 3 is a schematic diagram of operation principle of another exemplary apparatus for reducing bubbles in liquid according to some embodiments of the present disclosure. As shown in FIG. 2 and FIG. 3, the apparatus for reducing bubbles in liquid includes a bubble elimination structure 21 and a spiral structure 22. The bubble elimination structure 21 includes a plurality of bubble breaking elements 211. An axial direction of each bubble breaking element 211 is consistent with a liquid flow direction A. When the liquid flows through the plurality of bubble breaking elements 211, the plurality of bubble breaking elements 211 reduce the bubbles in the liquid. Along the liquid flow direction A, the spiral structure 22 is arranged at a front end of the bubble elimination structure 21. That is, the liquid first flows through the spiral structure 22, and then flows through the bubble elimination structure 21. The spiral structure 22 makes the liquid flow along the liquid flow direction A. A rotational movement of the liquid around the liquid flow direction A is generated to concentrate the bubbles in the liquid at the center of the liquid, and then the bubbles are reduced by the plurality of bubble breaking elements 211.

In the embodiments of the present disclosure, because the bubble elimination structure 21 with the plurality of bubble breaking elements 211 is provided in the apparatus for reducing bubbles in liquid, when the liquid flows through the bubble elimination structure 21, the plurality of bubble breaking elements 211 may squeeze and punctuate the bubbles. A punctuation force may break large bubbles and form small bubbles, thereby reducing the bubbles in the liquid. At the same time, along the liquid flow direction A, the spiral structure 22 is configured at a front end position before the liquid flows through the bubble elimination structure 21, and causes the liquid to make a rotational movement around the liquid flow direction A, such that the liquid flows in a spiral form. During the rotation of the liquid, the bubbles that are originally evenly dispersed in the liquid will be concentrated in the center of the liquid. Accordingly, the bubbles concentrated in the center of the liquid can be intensively broken, such that the large bubbles are broken into small bubbles, thereby preventing the large bubbles from adhering to the liquid delivery pipeline and being unable to be discharged. The plurality of bubble breaking elements 211 may be configured in the center of the bubble elimination structure 21, that is, the plurality of bubble breaking elements 211 are concentrated at the position where the bubbles in the liquid are concentrated. Thus, a configuration density of the plurality of bubble breaking elements 211 is increased, and the number of bubble breaking elements 211 arranged away from the center of the bubble elimination structure 21 is reduced. Alternatively, no bubble breaking elements may be configured at a position away from the center of the bubble elimination structure 21, thereby reducing the occurrence of bubbles flowing through gaps of the bubble breaking elements 211 without being broken, and also reducing resistance of the bubble elimination structure 21 to the liquid flow. Compared with related technologies, the apparatus for reducing bubbles in liquid provided by the embodiments of the present disclosure makes the liquid flow in the spiral form, thereby driving the bubbles attached to the liquid delivery pipeline to flow with the liquid. The bubbles in the liquid are concentrated in the center of the liquid flow to be broken, such that the efficiency of reducing bubbles in liquid can be improved.

To make the apparatus for reducing bubbles in liquid provided by the embodiments of the present disclosure easy to install in actual applications, as shown in FIG. 2, a flow guide housing 23 may also be provided in the apparatus for reducing bubbles in liquid. The flow guide housing 23 may have a cylindrical shape. The spiral structure 22 and the bubble elimination structure 21 are fixed on an inner wall of the cylindrical flow guide housing 23 such that the spiral structure 22 and the bubble elimination structure 21 are connected together as one piece. When installing the apparatus for reducing bubbles in liquid, the entire apparatus only needs to be connected to the liquid delivery pipeline 1.

For example, the flow guide housing 23 may be configured in a cylindrical shape that is adapted to the liquid delivery pipeline 1. The radial inner wall of the cylindrical flow guide housing 23 may also be configured in a cylindrical shape, and the radial outer wall may be configured in a shape that matches an inner wall of the liquid delivery pipeline 1, such that the apparatus can be inserted into the liquid delivery pipeline 1. Alternatively, the radial inner wall of the cylindrical flow guide housing 23 may be configured in a shape that matches an outer wall of the liquid delivery pipeline 1, and then a space is reserved at each end of the flow guide housing 23, such that both ends of the liquid delivery pipeline 1 can be respectively inserted into the two ends of the flow guide housing 23. Accordingly, the apparatus for reducing bubbles in liquid can be conveniently and quickly installed in the liquid delivery pipeline 1 through the above two structures.

The spiral structure 22 needs to be located at one end of the flow guide housing 23 where the liquid flows in, and the bubble elimination structure 21 needs to be located on the end of the flow guide housing 23 where the liquid flows out. In some embodiments, the apparatus 2 for reducing bubbles in liquid may be arranged at a liquid inlet end of the liquid delivery pipeline 1. In some embodiments, the apparatus 2 for reducing bubbles in liquid may also be arranged at a liquid outlet end of the liquid transport pipeline 1. In some embodiments, the apparatus 2 for reducing bubbles in liquid may be arranged near the middle section of the liquid delivery pipeline 1. In some embodiments, multiple apparatuses 2 for reducing bubbles in liquid may be arranged in the liquid delivery pipeline 1. In some embodiments, in an axial direction of the liquid delivery pipeline 1, the length of the spiral structure 22 may be arranged to run through the entire liquid delivery pipeline 1. The bubble elimination structure 21 may be arranged at a position close to an exhaust valve in the liquid delivery pipeline 1, and the bubble elimination structure 21 may be located at a front end of the exhaust valve to facilitate tiny bubbles formed from broken large bubbles to be discharged from the liquid delivery pipeline 1 through the exhaust valve.

It should be noted that the apparatus 2 for reducing bubbles in liquid provided in the embodiment of the present disclosure may not be provided with the flow guide housing 23, but the bubble elimination structure 21 and the spiral structure 22 may be configured in shapes that match the inner wall of the liquid delivery pipeline 1, and may be in respectively installed in the liquid delivery pipeline 1. The present disclosure does not limit the arrangement manner of the flow guide housing 23 and whether the flow guide housing 23 is provided.

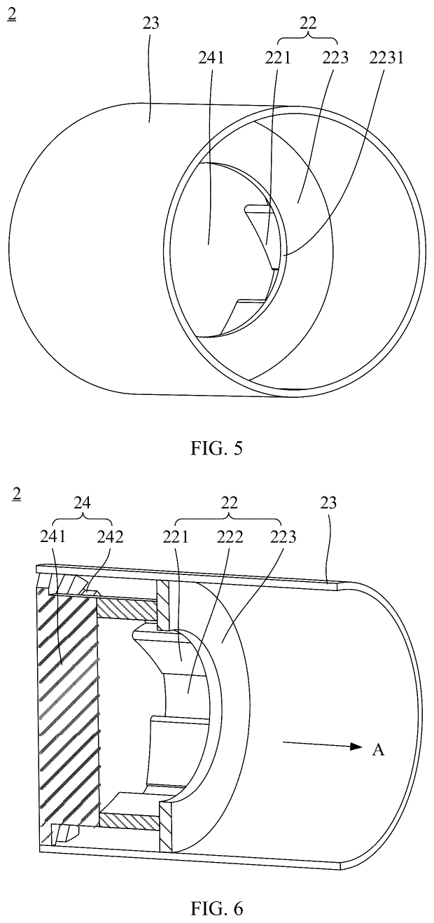

FIG. 4 is a schematic structural diagram of an exemplary apparatus for reducing bubbles in liquid according to some embodiments of the present disclosure. FIG. 5 is a schematic structural diagram of another exemplary apparatus for reducing bubbles in liquid according to some embodiments of the present disclosure. FIG. 6 is a cross-sectional view of an exemplary apparatus for reducing bubbles in liquid according to some embodiments of the present disclosure.

In some embodiments, as shown in FIGS. 4-6, the spiral structure 22 includes a plurality of wedges 221 arranged around the liquid flow direction A. A spiral channel 222 is formed between two adjacent wedges 221. When the liquid flows through the spiral channel 222, a rotational movement is generated around the liquid flow direction A. A rotation direction B of the rotational movement forms an angle with the liquid flow direction A. Thus, when the liquid generates the rotational movement, the liquid will flow along the liquid flow direction A in the spiral form.

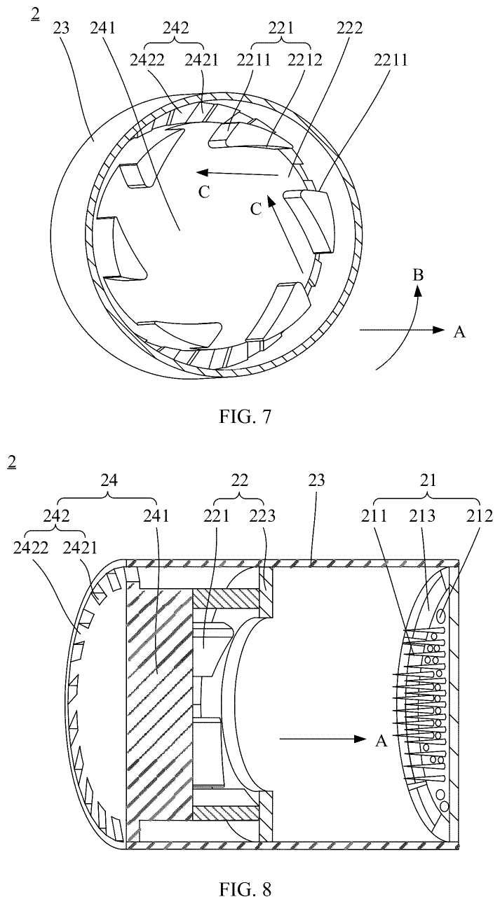

FIG. 7 is a cross-sectional view of another exemplary apparatus for reducing bubbles in liquid according to some embodiments of the present disclosure. For example, as shown in FIG. 7, a wedge 221 may be configured as a wedge-shaped structure with a triangular cross-section. The wedge 221 includes a first curved surface 2211 and a second curved surface 2212. A first angle is formed between the first curved surface 2211 and the second curved surface 2212. Among two adjacent wedges 221, the first curved surface 2211 of one wedge 221 and the second curved surface 2212 of the other wedge 221 are enclosed to form the spiral channel 222. A direction of each spiral channel 222 corresponds to the second curved surface 2212 of the other wedge 221.

For example, six wedges 221 may be provided. The six wedges 221 are evenly arranged on a same virtual ring around the liquid flow direction A. The axial direction of each wedge 221 is consistent with the liquid flow direction A. The angle formed between the first curved surface 2211 and the second curved surface 2212 of each wedge 221 may be set to 60°. Accordingly, the first curved surface 2211 and the second curved surface 2212 that form the spiral channel 222 on the two adjacent wedges 221 may be parallel, or nearly parallel, such that the spiral channel 222 formed between the two adjacent wedges 221 can be made to correspond to the second curved surface 2212 of a third wedge 221. It should be noted that the first angle formed between the first curved surface 2211 and the second curved surface 2212 on the wedge 221 may also be set to other angles, and the number of wedges 221 may also be set to other numbers. For example, the number of wedges 221 may be set to four, five, eight, etc., as long as a spiral channel 222 can be formed between two adjacent wedges 221, and a direction C of the spiral channel 222 surrounds the liquid flow direction A, which is not limited by the present disclosure.

In some embodiments, because multiple wedges 221 are provided on the spiral structure 22, and the axial direction of the wedges 221 is consistent with the liquid flow direction A, a spiral channel 222 may be formed between two adjacent wedges 221. The liquid can be made to generate the rotational movement around the liquid flow direction A while flowing along the liquid flow direction A, such that the liquid flows in the spiral form and the bubbles in the liquid can be concentrated in the center of the liquid. The spiral channel 222 formed between the first curved surface 2211 and the second curved surface 2212 on two wedges 221 corresponds to the second curved surface 2212 on the third wedge 221, such that the liquid that flows from the spiral channel 222 collides with the second curved surface 2212. Thus, a portion of the bubbles in the liquid are broken by a collision force, thereby reducing the portion of the bubbles.

In some embodiments, as shown in FIGS. 5 and 6, a stopper 223 may be provided on the spiral structure 22. The stopper 223 is provided on the same side of the plurality of wedges 221 and is connected to each of the plurality of wedges 221. The stopper 223 includes a liquid flow channel 2231, which is connected with each spiral channel 222. Along the liquid flow direction A, the stopper 223 is arranged at a rear end of each wedge 221. That is, the liquid first flows through the spiral channel 222 and then flows through the liquid flow channel 2231.

For example, the stopper 223 may be configured as a circular ring with the liquid flow channel 2231 in the center, and the axial sidewall of the circular ring is connected to the axial sidewall of each wedge 221. Accordingly, the first curved surface 2211 and the second curved surface 2212 on two wedges 221 and the sidewall of the circular ring are enclosed to form the spiral channel 222. Along the liquid flow direction A, the spiral channel 222 is blocked by the sidewalls of the circular ring. Thus, the liquid flowing through the spiral channel 222 can only flow along an extension direction of the spiral channel 222, but cannot flow along the liquid flow direction A and also flow along the extension direction of the spiral channel 222. Such a structural arrangement can make the forceful rotational movement of the liquid around the liquid flow direction A, and the stopper 223 and the wedges 221 are provided to reduce a channel area of the liquid flow. In the process of the liquid flowing through the spiral structure 22, the flow rate will increase, which will strengthen the rotational movement of the liquid, such that more bubbles in the liquid can be concentrated in the center of the liquid.

In some embodiments, as shown in FIGS. 5-7, a flow guide structure 24 may also be provided in the apparatus 2 for reducing bubbles in liquid provided in the embodiments of the present disclosure. Along the liquid flow direction A, the flow guide structure 24 is provided at the front end of the spiral structure 22. That is, the liquid first flows through the flow guide structure 24, and then flows through the spiral structure 22. The flow guide structure 24 allows the liquid to flow through the spiral channel 222.

For example, the flow guide structure 24 includes a flow guiding element 241, which is disposed at the center of the flow guide structure 24 in a direction perpendicular to the liquid flow direction A. The flow guiding element 241 is connected to the other axial sidewall of each wedge 221 to guide the liquid flow to the spiral channel 222. For example, the flow guiding element 241 may be configured as a cylinder. One end of the cylinder is connected to the axial sidewall of each wedge 221. The axial sidewall of the cylinder, the first curved surface 2211 and the second curved surface 2212 on two wedges 221, and the sidewall of the ring as the stopper 223 are enclosed to form the spiral channel 222. The spiral channel 222 is enclosed by four sides and has only one inlet and one outlet. After flowing through the cylinder, the liquid only flows into the spiral channel 222 through an end of the spiral channel 222 away from the center of the flow guiding element 241, and then flows out from another end of the spiral channel 222 close to the center of the flow guiding element 241, and finally flows to the liquid flow channel 2231 on the stopper 223.

In some embodiments, after the flow guide structure 24 is provided on the channel where the liquid flows, an area of the channel where the liquid flows will be further reduced, thereby increasing the local flow rate of the liquid, which allows the liquid to flow into the spiral channel 222 at a higher flow rate. When the liquid collides with the sidewall of the spiral channel 222, some large bubbles will be broken into small bubbles. At the same time, after the liquid flows through the spiral channel 222 at the higher flow rate, a more intense rotational movement may occur, such that more bubbles in the liquid are concentrated in the center of the liquid.

In some embodiments, as shown in FIGS. 4 and 7, the flow guide structure 24 further includes a flow draining element 242. The flow draining element 242 includes a flow drainer hole 2421 and a connection arm 2422. For example, in the radial direction of the flow guiding element 241, a plurality of flow drainer holes 2421 may be provided on the sidewall of the flow guiding element 241. An extension direction of the flow drainer holes 2421 is consistent with the liquid flow direction A, and the flow drainer holes 2421 are connected to the spiral channel 222. The flow guide structure 24 is fixed on the glow guide housing 23 through the connection arm 2422. The connection arm 2422 provided between the flow drainer holes 2421 will further reduce the area of the liquid circulation channel. During the process of liquid flow, due to the reduction in the area of the circulation channel, when the liquid flows through the flow drainer holes 2421, an increase in the local pressure of the liquid will cause some of the bubbles to be compressed and broken, and dispersed into small bubbles, such that the small bubbles can be discharged from the liquid.

FIG. 8 is a cross-sectional view of another exemplary apparatus for reducing bubbles in liquid according to some embodiments of the present disclosure. In some embodiments, as shown in FIG. 8, along the liquid flow direction A, the bubble elimination structure 21 is provided at the rear end of the spiral structure 22. After the liquid flows through the spiral structure 22, the liquid flows to the bubble elimination structure 21 in the spiral form. The bubbles concentrated in the center of the liquid encounter the bubble breaking elements 211 on the bubble elimination structure 21. After being squeezed and punctuated, the large bubbles are broken to form the small bubbles.

For example, the bubble breaking element 211 may be configured as a needle-punching element. That is, the bubble breaking element 211 is configured in a cone shape. The tip of the needle-punching element faces toward the spiral structure 22. A plurality of needle-punching elements are arranged at the center of the bubble elimination structure 21. Moreover, a plurality of through-holes 212 are provided among the plurality of needle-punching elements. A portion of the bubble elimination structure 21 away from the center position may be set as a circulation channel 213. A distance between the bubble breaking elements 211 and the stopper 223 may be determined according to accumulation of the bubbles in the liquid, such that the bubble breaking elements 211 are located at the position where the bubbles are most concentrated. This may reduce the number of the bubble breaking elements 211, thereby achieving the objective of using minimum number of the bubble breaking elements 211 to break more bubbles. The provided through-holes 212 and the circulation channel 213 reduce the flow resistance, allowing the broken small bubbles to quickly flow away with the liquid.

When using the apparatus for reducing bubbles in liquid provided by the embodiments of the present disclosure, the distance between the bubble breaking elements 211 may be determined based on the distance between fins of the heat dissipator. The distance between the bubble breaking elements 211 needs to be smaller than the distance between the fins of the heat dissipator. Accordingly, the bubbles after passing through the bubble breaking elements 211 may be turned into small bubbles with a diameter smaller than the distance between the fins of the heat dissipator, thereby reducing or even eliminating the bubbles remaining in the gaps between the fins of the heat dissipator. Thus, a large thermal resistance is prevented from being formed in the heat dissipator, and the cooling effect of the liquid cooling system is improved. At the same time, eliminating large bubbles may reduce the occurrence of cavitation, thereby increasing the service life of parts of the liquid cooling system.

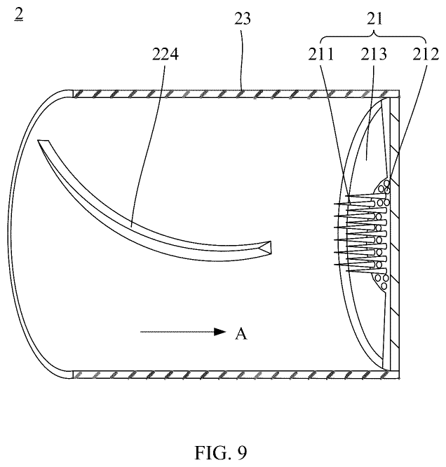

FIG. 9 is a cross-sectional view of another exemplary apparatus for reducing bubbles in liquid according to some embodiments of the present disclosure. In some embodiments, as shown in FIG. 9, the spiral structure 22 may be configured to include at least one spiral flow guide 224. Each spiral flow guide 224 extends along the liquid flow direction A in the spiral form.

For example, the spiral flow guide 224 may be configured as a spiral-shaped strip. Alternatively, the spiral flow guide 224 may be configured as a spiral-shaped plate. The spiral-shaped strip or the spiral-shaped plate extends along the liquid flow direction A in the spiral form. A plurality of spiral flow guides 224 may be fixed on the inner wall of the flow guide housing 23 and the plurality of spiral flow guides 224 may be evenly distributed along a circumferential direction of the flow guide housing 23. Alternatively, the plurality of spiral flow guides 224 may be provided on the inner wall of the liquid delivery pipeline 1. The plurality of spiral flow guides 224 may be evenly arranged along a circumferential direction of the liquid delivery pipeline 1, and the plurality of spiral flow guides 224 may extend a sufficient length in the liquid delivery pipeline 1. Accordingly, when the liquid flows through the plurality of spiral flow guides 224, due to the resistance in the liquid flow direction A, the liquid will flow along spiral surfaces of the plurality of spiral flow guides 224, thereby generating a rotational movement around the liquid flow direction A. During the rotation of the liquid, the bubbles evenly dispersed in the liquid gather towards the center of the liquid. With the flow of the liquid, the rotational movement is strengthened to cause all the bubbles in the liquid to concentrate to the center of the liquid. The plurality of bubble breaking elements 211 provided at the center of the liquid punctuate the large bubbles to form the small bubbles, such that the bubbles can be easily discharged from the liquid delivery pipeline into the exhaust valve, and the objective of eliminating bubbles in the liquid can be achieved.

The above are merely some embodiments of the present disclosure, and are not intended to limit the scope of the present disclosure. Any equivalent structure or equivalent process transformation made using the contents of the description and drawings of the present disclosure may be directly or indirectly used in other related technical fields, and are all equally included in the protection scope of the present disclosure.

What is claimed is:

1. An apparatus for reducing bubbles in liquid, comprising:
a bubble elimination structure including a plurality of bubble breaking elements being used to reduce the bubbles in the liquid, an axial direction of each bubble breaking element being consistent with a liquid flow direction; and
a spiral structure configured to generate a spiral movement of the liquid around the liquid flow direction to concentrate the bubbles in the liquid in the center of the liquid,
wherein the liquid flows through the spiral structure before flowing through the bubble elimination structure.

2. The apparatus according to claim 1, wherein:
the spiral structure includes a plurality of wedges arranged around the liquid flow direction;
a spiral channel is formed between two adjacent wedges; and
when the liquid flows through the spiral channel, a rotational movement of the liquid around the liquid flow direction is generated.

3. The apparatus according to claim 2, wherein:
each wedge includes a first curved surface and a second curved surface;
a first angle is formed between the first curved surface and the second curved surface;
the first curved surface of one wedge and the second curved surface of another adjacent wedge are enclosed to form the spiral channel; and
a direction of each spiral channel corresponds to the second curved surface of the adjacent wedge.

4. The apparatus according to claim 2, wherein:
the spiral structure further includes a stopper arranged on a same side of the plurality of wedges and connected to each and every wedge;
the stopper includes a liquid flow channel connected with each spiral channel; and
the stopper causes the liquid to flow through the spiral channel before flowing through the liquid flow channel.

5. The apparatus according to claim 2, further comprising:
a flow guide structure connected to the spiral structure and configured to cause the liquid to flow through the spiral channel.

6. The apparatus according to claim 5, wherein:
the flow guide structure includes a flow guiding element, which is disposed at the center of the flow guide structure in a direction perpendicular to the liquid flow direction; and
the flow guiding element is connected to each wedge to guide the liquid flow to the spiral channel.

7. The apparatus according to claim 1, wherein:
the spiral structure includes at least one spiral flow guide; and
each spiral flow guide extends along the liquid flow direction A in the spiral form.

8. The apparatus according to claim 1, wherein:
the bubble elimination structure further includes a plurality of through-holes;
the plurality of bubble breaking elements are arranged among the plurality of through-holes;
each bubble breaking element is a needle-punching element; and
a tip of the needle-punching element faces toward the spiral structure.

9. The apparatus according to claim 1, further comprising:
a flow guide housing;
wherein the bubble elimination structure is located on an end of the flow guide housing where the liquid flows out, and the spiral structure is located at the other end of the flow guide housing where the liquid flows in.

10. An electronic device, comprising:
a heating element generates a large amount of heat during operation; and
a liquid cooling system configured to cool down the heating element and including a liquid delivery pipeline connected to the heating element and an apparatus for reducing bubbles in liquid arranged in the liquid delivery pipeline and configured to reduce bubbles in the liquid circulated in the liquid delivery pipeline;
wherein the apparatus for reducing bubbles in liquid includes:
a bubble elimination structure including a plurality of bubble breaking elements being used to reduce the bubbles in the liquid, an axial direction of each bubble breaking element being consistent with a liquid flow direction; and
a spiral structure configured to generate a spiral movement of the liquid around the liquid flow direction to concentrate the bubbles in the liquid in the center of the liquid,
wherein the liquid flows through the spiral structure before flowing through the bubble elimination structure.

11. The electronic device according to claim 10, wherein:
the spiral structure includes a plurality of wedges arranged around the liquid flow direction;
a spiral channel is formed between two adjacent wedges; and
when the liquid flows through the spiral channel, a rotational movement of the liquid around the liquid flow direction is generated.

12. The electronic device according to claim 11, wherein:
each wedge includes a first curved surface and a second curved surface;
a first angle is formed between the first curved surface and the second curved surface;
the first curved surface of one wedge and the second curved surface of another adjacent wedge are enclosed to form the spiral channel; and
a direction of each spiral channel corresponds to the second curved surface of the adjacent wedge.

13. The electronic device according to claim 11, wherein:
the spiral structure further includes a stopper arranged on a same side of the plurality of wedges and connected to each and every wedge;
the stopper includes a liquid flow channel connected with each spiral channel; and
the stopper causes the liquid to flow through the spiral channel before flowing through the liquid flow channel.

14. The electronic device according to claim 11, wherein:
the apparatus for reducing bubbles in liquid further includes a flow guide structure connected to the spiral structure and configured to cause the liquid to flow through the spiral channel.

15. The electronic device according to claim 14, wherein:
the flow guide structure includes a flow guiding element, which is disposed at the center of the flow guide structure in a direction perpendicular to the liquid flow direction; and
the flow guiding element is connected to each wedge to guide the liquid flow to the spiral channel.

16. The electronic device according to claim 10, wherein:
the spiral structure includes at least one spiral flow guide; and
each spiral flow guide extends along the liquid flow direction A in the spiral form.

17. The electronic device according to claim 10, wherein:
the bubble elimination structure further includes a plurality of through-holes;
the plurality of bubble breaking elements are arranged among the plurality of through-holes;
each bubble breaking element is a needle-punching element; and
a tip of the needle-punching element faces toward the spiral structure.

18. The electronic device according to claim 10, wherein:
the apparatus for reducing bubbles in liquid further includes a flow guide housing; and
the bubble elimination structure is located on an end of the flow guide housing where the liquid flows out, and the spiral structure is located at the other end of the flow guide housing where the liquid flows in.
